(19) United States
(12) Patent Application Publication
(10) Pub. No.: US 2015/0375697 A1
(43) Pub. Date: Dec. 31, 2015

(54) Automobile Generator System

(71) Applicants: Rick Malkonian, Hastings, MI (US); Patrick Flynn, Edenton, NC (US)

(72) Inventors: Rick Malkonian, Hastings, MI (US); Patrick Flynn, Edenton, NC (US)

(21) Appl. No.: 13/761,844

(22) Filed: Feb. 7, 2013

(51) Int. Cl. B60R 16/033; B60L 11/18

(52) U.S. Cl. CPC B60R 16/033; B60L 11/1809; B60L 11/1803

(57) ABSTRACT

An Automobile Generator System (AGS) to mechanically engage and sustain energy flow to AGS motor system components to operate an automobile.

### FEDERALLY SPONSORED RESEARCH

Not Applicable

### SEQUENCE LISTING, OR PROGRAM

Not Applicable

An automobile motor requires constant liquid fuel, which can limit its usefulness in some applications. In one invention, a generator connected to the automobile's wheels charges a battery system that operates an electric motor joined to a liquid fuel motor. The Automobile Generator System (AGS) idea of “continuously” is worlds apart from current understanding. This invention turns current technology scenarios around to define practically many applications of the proverbial “perpetual motion machine”.

An automobile generator connected to a motor typically adapts a belt system to produce and then store energy in a battery for automobile use. Traditional fan belt systems, even a second motor attached to a liquid fuel motor, means having a limited placement location for a generic, belt-driven generator. Redefining the way an automobile generator attaches to a motor is one way to revise current technology into “green” technology system improvements.

Any green technology should suggest smaller, more efficient internal combustion engines or useful innovations. This present invention replaces the traditional fan belt with a gear/flywheel/spline/pulley for energy production. While fan belts may still be used with the AGS the preferred embodiment connects relocated automobile generators to a motor-enabled shaft/spline. A gear/flywheel/spline/pulley system joined anywhere along the automobile's motor system, including the transmission, clutch/gearbox, motor housing and/or its supporting components thereby innovates and extends the functionality of the traditional motor-generator system many times over. Further, a series of automobile generators along the driveshaft/drivetrain can separately distribute power to accessories needing on-demand and/or stored power.

Hybrid systems require constant performance monitoring. Maintaining many energy destinations from one output source needlessly complicates circuitry, hardware and software design, especially with the parallel processing preferable in current computer design. Enabling and monitoring any electrical and/or mechanical energy system in an automobile also requires an overlapping redundancy of hardware and software functions, which further complicate hardware, circuitry, and software design and testing. This invention simplifies automobile generator system control and operation because a separate generator can be dedicated to each energy destination as needed.

Saving fossil fuel and other natural resources should be the primary aim in any new automobile motor design. Current, all-electric automobile motor technology requires many batteries, adding unnecessary bulk and weight to automobile design resulting in a limited operating range. This present invention suggests smaller, more numerous automobile generators coupled to a smaller automobile motor, i.e., a motor and automobile battery system that more efficiently uses, stores and provides the energy necessary to operate an automobile.

### BACKGROUND OF THE INVENTION

1. Field of the Invention

This invention relates generally to automobile motors, more particularly, to a method of generating, maintaining and monitoring constant, uninterrupted electric and/or mechanical energy flow from an automobile motor to fulfill the operational power needs of an automobile.

2. Discussion of Related Art

Defining minimum patent scope should be one goal in writing any specification. This is opposed to explaining generic functionality of the device or invention. Without some idea of what an invention will offer in real-world applications, any practical application picture exists out there, somewhere beyond its approved specification. Alternatively, the AGS is not necessarily concerned with existing patent specificity because a generic or universal AGS innovates existing inventions or generic functions to produce new, overriding and more practical automobile applications. For this reason, generic understanding of every motor and device component is not necessary promoted or outlined in this specification because of its narrower teaching nature.

Exclusively detailing specific technology in an invention without defining its scope actually works against understanding the overall, “universal” scope of accepted specifications. Specifications not expanding a patent's generic use or universality with some written disclosure, even though a claimant was granted universal definition, limits that patent as an example of the prior art, with the implication that its claims do not impact any new technology innovation and limits the patent's scope.

Accordingly, numerous patents have problems when compared to the AGS with its original self-sustaining, clean energy designs. Common problems in current patent specifications and the art are that they: do not predict a plurality of generators attached to the automobile's motor, transmission and/or their components; utilize outdated technology; have a system controller/microprocessor that distributes, maintains and/or monitors energy to a few, selected automobile functions in complex ways; do not eliminate the need for fuel altogether or provide unlimited operating range in all-electric automobile systems; have automobile generators requiring a liquid fuel motor to operate; do not have a plurality of the generators functioning at any point along the automobile motor or transmission system; do not have a generator system, gear, spline, flywheel, pulley and/or their supporting components functioning anywhere in or on the automobile motor system, including the transmission system, axle, driveshaft, drivetrain, motor housing, mechanical linkages, other generic motor system components, or combinations thereof; do not reduce engine size and weight; and/or do not have a self-sustaining motor system. Comparatively, a patent with any disadvantage detailed in this section makes the AGS unique, innovative and patentable in the art. Conversely, if this new system uniquely applies a plurality of universal components it is patentable.

The AGS uniquely combines a transmission and a plurality of motors, alternators, generators, alternator-generators, batteries, mechanical linkages, throttles, rotating motor shafts, splines, drivetrains, driveshafts, clutch/gearboxes, gears, flywheels, pulleys, inverters, rectifiers, system controllers, housings, motor housings, automobile electrical accessories, gas pedals, wheels, other generic motor system components, or combinations thereof into a system that can be specifically arranged and applied in automobiles. Representative examples with their specific disadvantages in the current art are discussed below and, as applicable, other applicable patents reference portions of analysis in this section.

U.S. Pat. No. 4,477,764 to Pollard essentially teaches the battery-charging capability of the AGS, but he does not explain how a self-sustaining battery system functions in the broader context of automobile operations. While a plurality of the generators and alternators are specified a system controller is not predicted.

Bulky or unnecessary components are typical of technology pre-dating electronic and digital advancements. More importantly, separate pullies joining an electric motor to an alternator are non-essential, outdated technology components. His pulley system is unnecessary in light of the AGS generator system specifying a plurality of alternators and/or generators directly joined to the automobile motor, transmission, motor housing and/or its supporting components. Outdated gravity, speed and accelerator switch technology components pre-date microprocessors that have become standard usage in modern energy distribution systems.

U.S. Pat. No. 5,686,818 to Scaduto shows a generator mounted on the rear axle charging a battery system in an all-electric automobile. An automobile's wheel rotation joins couplers and shafts to mechanically operate two generators that supply power to separate electric motors apparently attached to the front axles. A voltage regular is apparently wire-linked to each generator apparently wire-linked to a controller. Only two generators supply energy to the automobile. Generator placement is fixed at one location on the automobile, as is the location of the one controller.

The majority of AGS functions are not predicted with Scaduto. For instance, the automobile must be in motion in order for battery charging to occur, a serious flaw, as idling depletes the energy stored in an automobile battery system. End of vehicle controller and generator functionality. His invention is too limited in that each bank of batteries functions with the motor only. Common automobile electrical accessories are not considered components that his controller manages. Scaduto's controller unlike the AGS controller has limited functionality.

U.S. Pat. No. 6,118,194 to Kawamura shows a plurality of automobile generators mounted adjacent to a motor flywheel. This placement limits the useful total of generators to the generators alignable around a flywheel. While the flywheel's exact placement on the motor block/transmission is not specified, a normal placement between an automobile motor and a transmission is assumed, which limits the invention's scope in relation to the GEMS invention.

Precision motor and transmission components need to be protected from adverse conditions. Instead, Kawamura leaves a gapping, uncovered space with automobile motor and transmission components at risk. Kawamura does not predict a self-sustaining, automobile motor system because of a liquid fuel motor with his system requires an external power source to maintain automobile motor operation.

Two sets of fan belts mechanically engaging several generators are the focus and/or purpose of Kawamura. Fan belts become practically unnecessary or are eliminated with the AGS. Also, generators do not need to be attached directly to the driveshaft/drivetrain but may independently synchronize with driveshaft/drivetrain rotation and be independently removable.

U.S. Pat. No. 6,481,516 to Field et al. focuses on a battery charging system for hybrid automobiles. A second electrical motor coupled to the primary liquid fuel motor powers automobile electrical accessories and batteries. His “process controller” is a computer-like device not specifically described. Field also doesn't detail how the electric motor specifically joins the primary motor. Tapping power from engine operations means an automobile electric system waits for the engine to be engaged before recharging the battery.

His hybrid engine is not specifically designed to reduce the size of the primary internal combustion engine, but Field claims a smaller motor. The AGS manages this automobile function in a self-sustaining manner.

Additionally, the AGS generator system directly powers a primary automobile motor. Functions that control a motor shaft/spline operating mechanical linkages operate, or the primary automobile motor itself directly operates a plurality of the wheels, rotating shaft/splines, flywheels, pulleys, planetary gears and/or its supporting components. Field's motor does not have these innovations.

Field's “bulky” generator is exchanged for a “bulky” motor tied to unspecified mechanical linkages. The AGS optimally utilizes multiple mechanical linkage components independent of any mechanical linkage the primary motor engages. Field's generator mechanically engages an automobile wheel system, which produces more cost, weight and complexity when compared to the automobile motor system and generator system the AGS proposes for multiple energy sources.

U.S. Pat. No. 7,293,621 to Long describes the operation of an energy recovery system that is not mechanically self-sustaining. Though Long describes technology applicable to universal automobile operation he does not predict the use of the transmission and a plurality of the gears, flywheels, splines, pulleys, clutches, gearboxes, housings, driveshafts/drivetrains, mechanical linkages, system controllers, gearshifts, throttles, motor housings, etc., or their supporting components the AGS will employ in its many embodiments.

In U.S. Pat. No. 7,648,785 to Hu et al. a motor drives the axle and/or the axle drives the motor. A fuel cell system engages the motor to increase its power. While the AGS does not exclude prohibitively expensive fuel cells, the AGS is employable with or adaptable to existing motor technology.

A liquid fuel motor joined to a generator for automobile electrical energy production is not unique in utility patent art. It is generic. Accordingly, charging an automobile battery system to full power is not unique. Also, Hu's Clean Power System is contingent on a primary liquid fuel motor to initiate and maintain automobile operations. Male and female AGS components will create self-sustaining energy. Further, Hu does not predict a plurality of the generators functioning at any point along the automobile motor system mechanically powering the wheels.

### SUMMARY OF THE INVENTION

It is an object of the invention to create an automobile motor system designed, or one that can be adapted to function with an automobile.

It is another object of the invention to create a generator system designed, or one that can be adapted to function with an automobile.

It is an object of the invention to create an automobile motor system and generator system designed, or one that can be adapted to function with an automobile in a self-sustaining manner.

### DRAWINGS

In the drawings—

FIG. 1 is illustrative of the AGS automobile motor system.

FIG. 2 is illustrative of an alternative automobile motor system.

FIG. 3 is illustrative of an alternative automobile motor system.

FIG. 4 is illustrative of an alternative automobile motor system.

FIG. 5 is illustrative of an alternative automobile motor system.

FIG. 6 is illustrative of an alternative automobile motor system.

FIG. 7 is alternative of an alternative automobile motor system.

FIG. 8 is illustrative of AGS battery recharging components.

FIG. 9 is illustrative of an alternative automobile motor system.

FIG. 10 is illustrative of the scope of the invention's strategy.

FIG. 11 is an alternative embodiment of the scope of the invention's strategy.

FIG. 12 is illustrative of an alternative automobile motor system.

FIG. 13 is illustrative of an alternative automobile motor system.

FIG. 14 is illustrative of an alternative automobile motor system.

FIG. 15 is illustrative of an alternative automobile motor system.

FIG. 16 is illustrative of an alternative automobile motor system.

FIG. 17 is illustrative of an alternative automobile motor system.

FIG. 18 is illustrative of an alternative automobile motor system.

FIG. 19 is illustrative of an alternative automobile motor system.

FIG. 20 is illustrative of an alternative automobile motor system.

FIG. 21 is illustrative of an alternative automobile motor system.

FIG. 22 is illustrative of an alternative automobile motor system.

FIG. 23 is illustrative of an alternative automobile motor system.

### REFERENCE NUMERALS IN THE DRAWINGS

| | |
|---|---|
| 100—the Automobile | 110—Wires to the Battery System |
| 120—System Controller | 130—Generator System |
| 140—Battery System | 150—Gear/Flywheel/Spline/Pulley |
| | System |
| 160—Gearshift/Throttle System | 170—the Motor System |
| 180—Motor | 190—Housing |
| 200—Motor Shaft/Spline | 210—Transmission |
| 220—Clutch/Gearbox | 230—Electrical Accessories |
| 240—Transmission System | 250—Motor Housing |
| 260—the Mechanical Linkage System | 270—the Axle/Wheels/Rotating |
| | Shaft/Spline |

### DESCRIPTION AND OPERATION OF THE DRAWINGS

Drawing elements with similar character references throughout the several views denote comparable components or functionality, or denote generic components and/or functionality in the art and apply to similar drawing functionality throughout the specification. For example, the Motor System 170, with either an electric or internal combustion engine interchangeable in the drawings, refers to duplicate capabilities and components in any drawing that has commonly understood mechanical functions. Additionally, pulley components may comprise Gear/Flywheel/Spline/Pulley System 150 or the Axle/Wheels/Rotating Shaft/Spline 270 components and/or their supporting components.

In another example, the Motor System 170 is comprised of combinations of the Generator System 130, Gear/Flywheel/Spline/Pulley System 150, Gearshift/Throttle 160, Motor Shaft/Spline 200, Transmission 210, Clutch/Gearbox 220, Electrical Accessories 230, Transmission System 240, Motor Housing 250 components and/or their supporting components are used depending on which embodiment of the invention is produced. In another example, the Transmission System 240 is comprised of combinations of the Generator System 130, Gear/Flywheel/Spline/Pulley System 150, Gearshift/Throttle 160, Motor Shaft/Spline 200, one Transmission 210, Clutch/Gearbox 220, Electrical Accessories 230, Motor Housing 250 and/or their supporting components depending on which embodiment of the invention is used.

In another example, each Generator System 130 attaches anywhere on the Motor System 170 in any practical manner and is most often mechanically joined to the Motor Shaft/Spline 200 to generate self sustaining energy for the automobile's operation. The Motor Shaft/Spline 200 component optionally engages the operation of a plurality of the Mechanical Linkage System 260 component to operate the automobile. The Mechanical Linkage System 260 engages other AGS components or functions.

In another example, the Housing 190 component optionally protects each Generator System 130 from adverse environmental impact. Each Generator System 130 mechanically engages a Gear/Flywheel/Spline/Pulley System 150 mechanically joined to the Motor System 170. The Generator System 130 attaches to the Motor System 170 via bracket or bolting systems.

While reference to the embodiments in the drawings will be made in this specification it is understood that no limitation of the scope of the invention is thereby intended. Any alterations and further modifications of the invention illustrated herein, and any additional applications of the principles of the invention as illustrated herein, which would normally occur to one skilled in the relevant art and having possession of the disclosure, are to be considered within the invention's claimed scope.

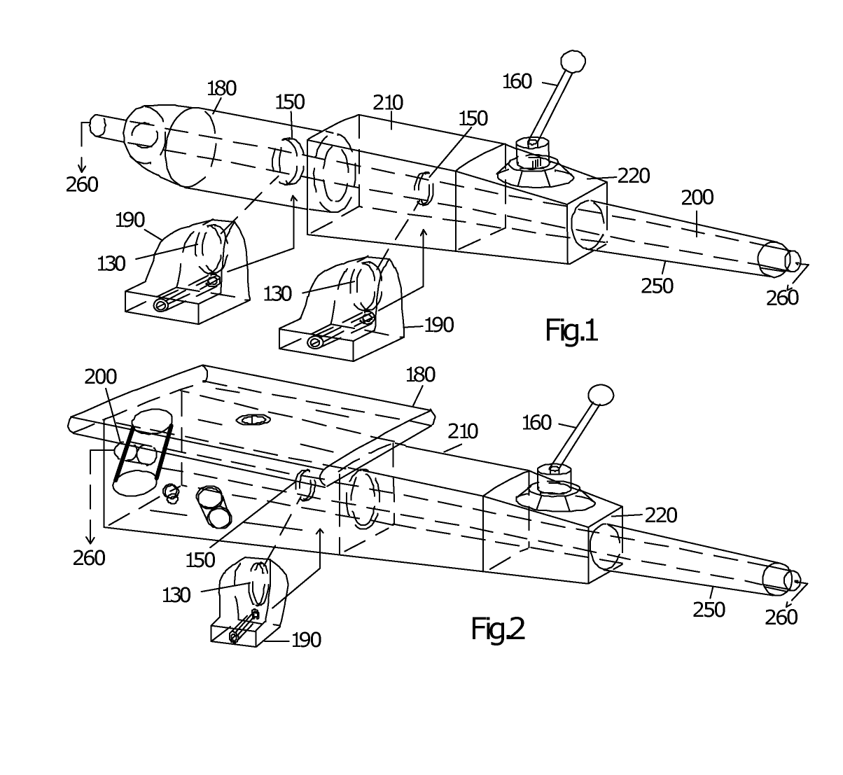

### FIG. 1

In the AGS Motor System 170 the Motor 180 operating the Motor Shaft/Spline 200 component connects to a Transmission System 240. The Transmission System 240 is variably controlled with a Gearshift/Throttle 160 depending upon the Motor 180 used.

The Motor Shaft/Spline 200 component optionally engages a plurality of the Mechanical Linkage System 260 component (not shown). The Mechanical Linkage System 260 alternatively engages other AGS components or functions such as axles, wheels, etc. to operate the automobile.

A plurality of the Housing 190 component protects each Generator System 130 from adverse environmental impact. Each Generator System 130 mechanically engages a Gear/Flywheel/Spline/Pulley System 150 mechanically joined to the Motor System 170. The Generator System 130 attaches to the Motor System 170 via bracket or bolting systems.

### FIG. 2

An alternative embodiment of the AGS.

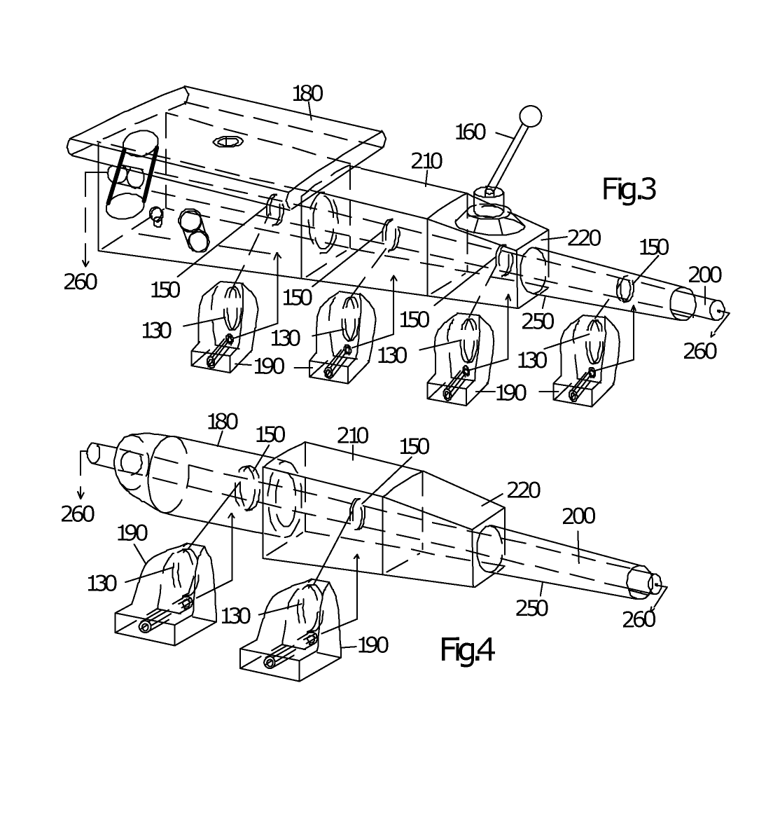

### FIG. 3

An alternative embodiment of the AGS. In this illustration the Motor Shaft/Spline 200 component optionally engages a plurality of the Generator System 130 component.

### FIG. 4

An alternative embodiment of the AGS. The operation of the Motor System 170 is variably controlled with the System Controller 120 (not pictured) connected to a Gearshift/Throttle System 160 (not pictured).

### FIG. 5

An alternative embodiment of the AGS.

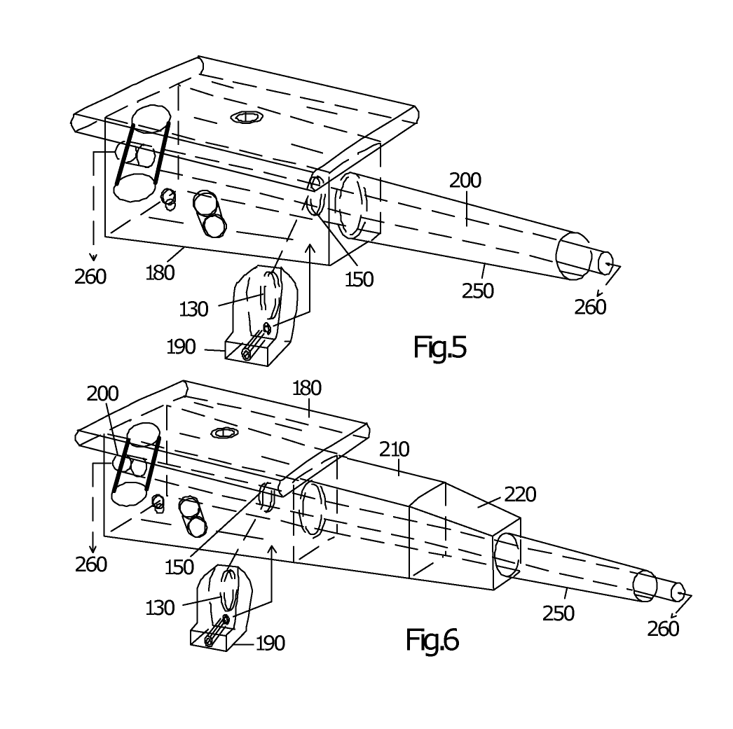

### FIG. 6

An alternative embodiment of the AGS.

### FIG. 7

An alternative embodiment of the AGS.

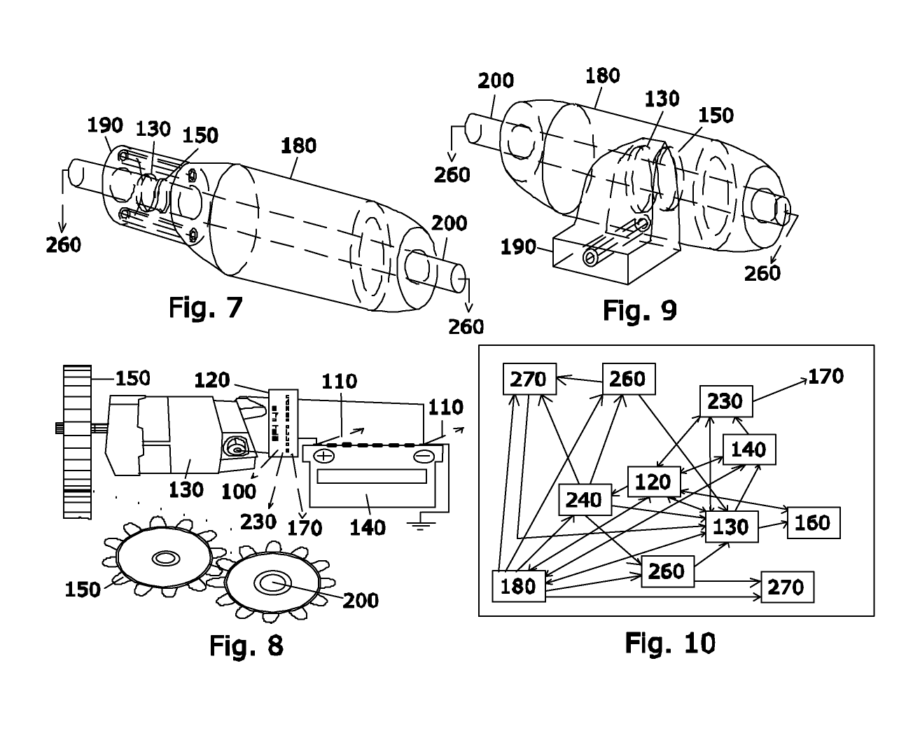

### FIG. 8

The AGS Battery System 140 is charged with a Generator System 130 connected to the AGS Motor System 170 (not pictured) via a Motor Shaft/Spline 200 and/or a Gear/Flywheel/Spline/Pulley System 150. Energy provided by the Generator System 130 is directed to a System Controller 120 that distributes it to the Automobile 100, Battery System 140, Motor System 170 and/or Electrical Accessories 230. The Generator System 130 mechanically engages the Motor System 170 in many alternative embodiments.

### FIG. 9

An alternative embodiment of the AGS.

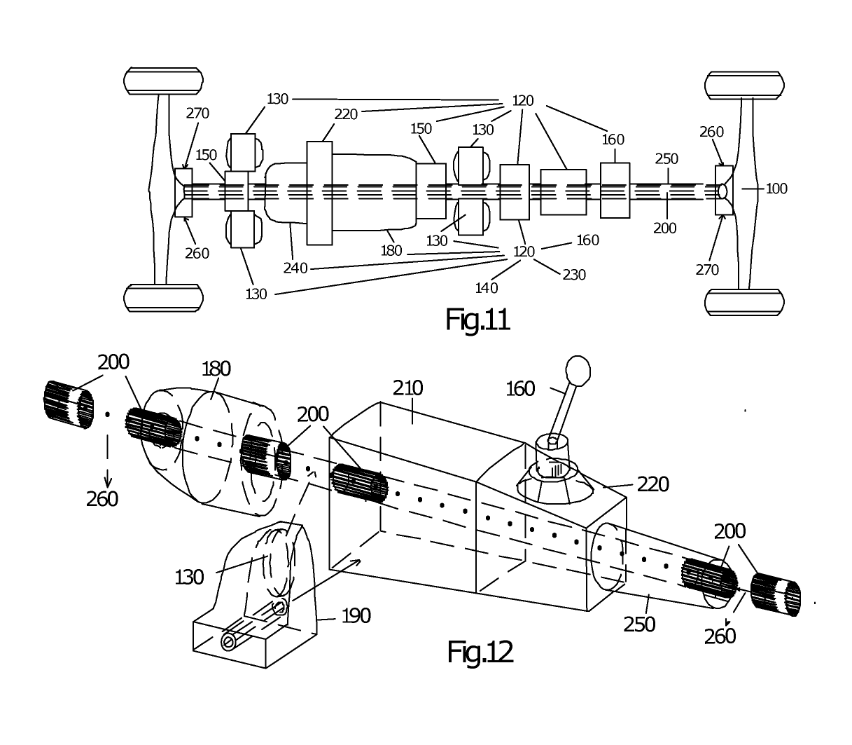

### FIG. 10

The AGS Motor System 170 is comprised of the Motor 180 operating a Generator System 130 that supplies energy to the System Controller 120, Battery System 140 and/or Motor 180. In alternative embodiments the Generator System 130 also supplies energy to the Electrical Accessories 230 and/or other generic components.

The System Controller 120 monitors, distributes and/or maintains energy flow to a plurality of AGS components including, but not limited to managing energy to the Generator System 130, Battery System 140, Motor 180, one Transmission System 240 and/or Electrical Accessories 230.

Contingent on AGS design needs, the Motor 180 is optionally connected to the Transmission System 240, Mechanical Linkage System 260 and/or Axle/Wheels/Rotating Shaft/Spline 270 component. Considering impractical locations, a plurality of the Generator System 130 component mechanically engages the functions of the Motor 180, Transmission System 240, Mechanical Linkage System 260 and/or Axle/Wheels/Rotating Shaft/Spline 270.

The AGS in this illustration is alternatively connected to a plurality of other AGS components. The Motor System 170 directly or indirectly engages a plurality of automobile motor shafts/splines, mechanical linkages, axles, gears, flywheels, wheels, rotating shafts/splines, pulleys, etc. on the same motor though some of these AGS components are not represented in this figure.

### FIG. 11

The Motor 180 operates the Motor Shaft/Spline 200 component connected in whole or in part to the other components of the Motor System 170 including, but not limited to the Clutch/Gearbox 220 and Transmission System 240. The Motor 180 directly or indirectly mechanically engages each Generator System 130 component mechanically joined to a Motor Shaft/Spline 200 component and/or to a Gear/Flywheel/Spline/Pulley System 150 component.

The Generator System 130 comprised of a plurality of Generator System 130 components supplies energy to the System Controller 120, Battery System 140, Motor 180, Electrical Accessories 230 and/or other Motor System 170 components. Both the Generator System 130 and the Battery System 140 supplement any operational energy loss in the Automobile 100. The System Controller 120 monitors, distributes and/or maintains energy flow to the AGS.

Contingent on AGS design, the Motor 180 is connected to the Transmission System 240, Mechanical Linkage System 260 and/or Axle/Wheels/Rotating Shaft/Spline 270. Considering impractical locations, a plurality of the Generator System 130 component functions anywhere on the Motor System 170.

The AGS in this illustration is alternatively connected to a plurality of other AGS components. The Motor System 170 directly or indirectly engages a plurality of automobile motor shafts/splines, mechanical linkages, axles, gears, flywheels, wheels, rotating shafts/splines, pulleys, etc. from the same motor though some of these AGS components are not represented in this figure.

### FIG. 12

An alternative embodiment of the AGS.

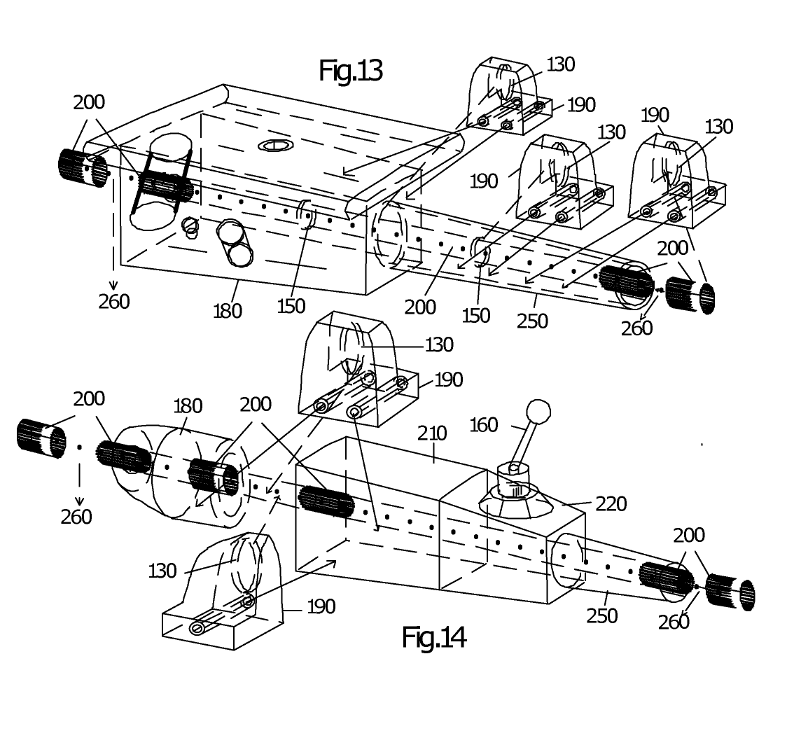

### FIG. 13

An alternative embodiment of the AGS.

### FIG. 14

An alternative embodiment of the AGS.

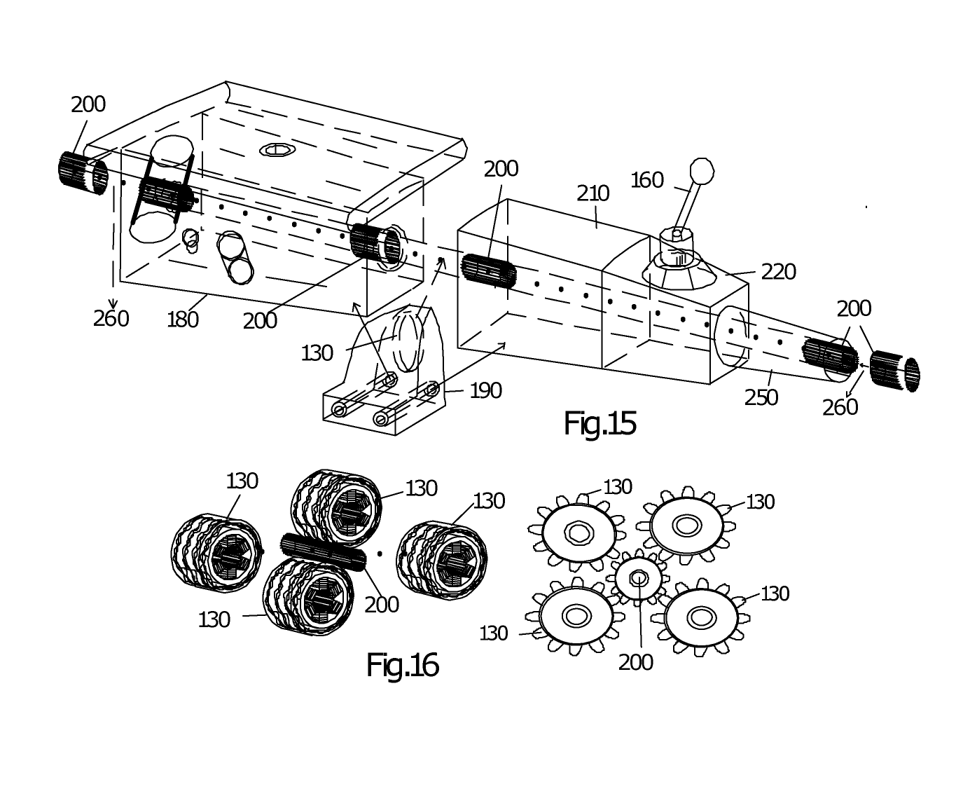

### FIG. 15

An alternative embodiment of the AGS.

### FIG. 16

The Generator and Motor System 170 (not pictured) operates a plurality of the Motor Shaft/Spline 200 component that mechanically engages a plurality of the Mechanical Linkage System 260 component (not pictured) and optional Propeller 280 (not pictured) component. Also not pictured is a Housing 190 that protects the Generator System 130 from adverse environmental impact. The Generator System 130 mechanically engages the Generator and Motor System 170 and attaches to the Generator and Motor System 170 or the Automobile 100 via bracket or bolting systems.

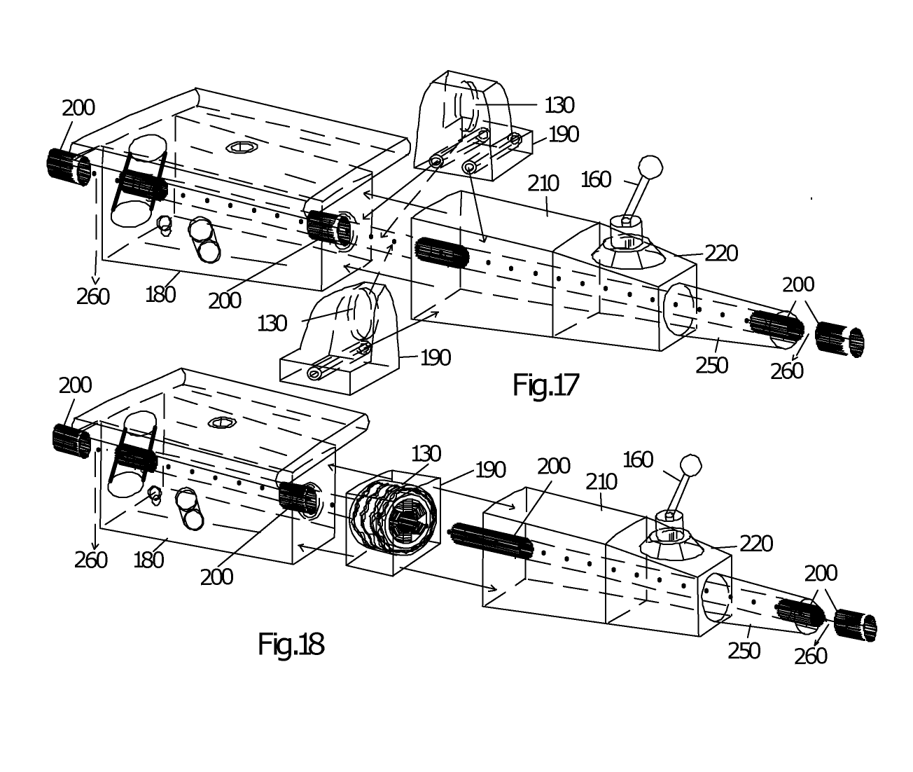

### FIG. 17

An alternative embodiment of the AGS.

### FIG. 18

An alternative embodiment of the AGS.

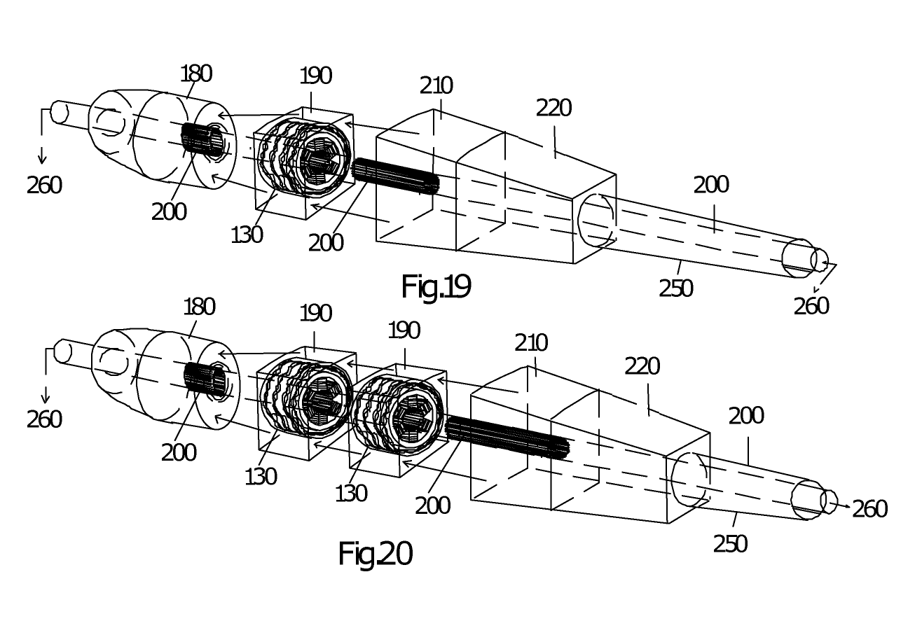

### FIG. 19

An alternative embodiment of the AGS.

### FIG. 20

An alternative embodiment of the AGS. In this illustration the Motor Shaft/Spline 200 component optionally engages a plurality of the Generator System 130 component functioning with the Motor System 170 and Transmission System 240. Each Generator System 130 mechanically engages the Motor System 170. The Generator System 130 attaches to the Motor System 170 and/or the Transmission System 240 via bracket or bolting systems.

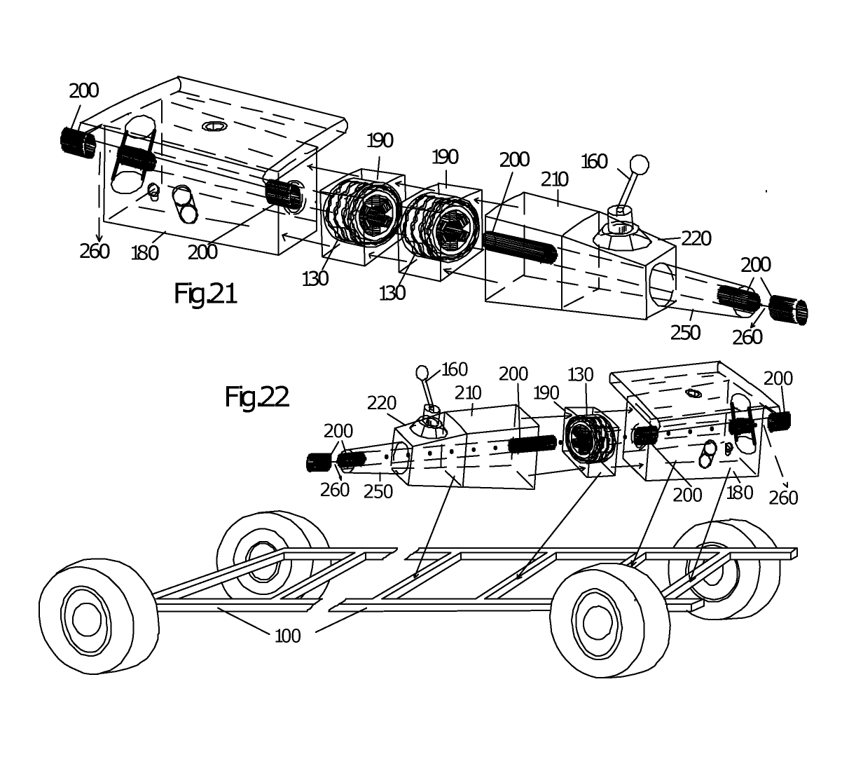

### FIG. 21

An alternative embodiment of the AGS. In this illustration the Motor Shaft/Spline 200 component optionally engages a plurality of the Generator System 130 component functioning with the Motor System 170 and Transmission System 240.

### FIG. 22

In an alternative embodiment of the AGS Motor System 170 the Motor 180 connects to the Transmission System 240. The Motor Shaft/Spline 200 component mechanically engages the Generator System 130 functioning with the Motor System 170 and Transmission System 240. Each Generator System 130 component mechanically engages the Motor System 170. The Generator System 130 attaches to the Motor System 170 and/or the Transmission System 240 via bracket or bolting systems. The Motor System 170 and/or the Transmission System 240 attach to the Automobile 100 via bracket or bolting systems.

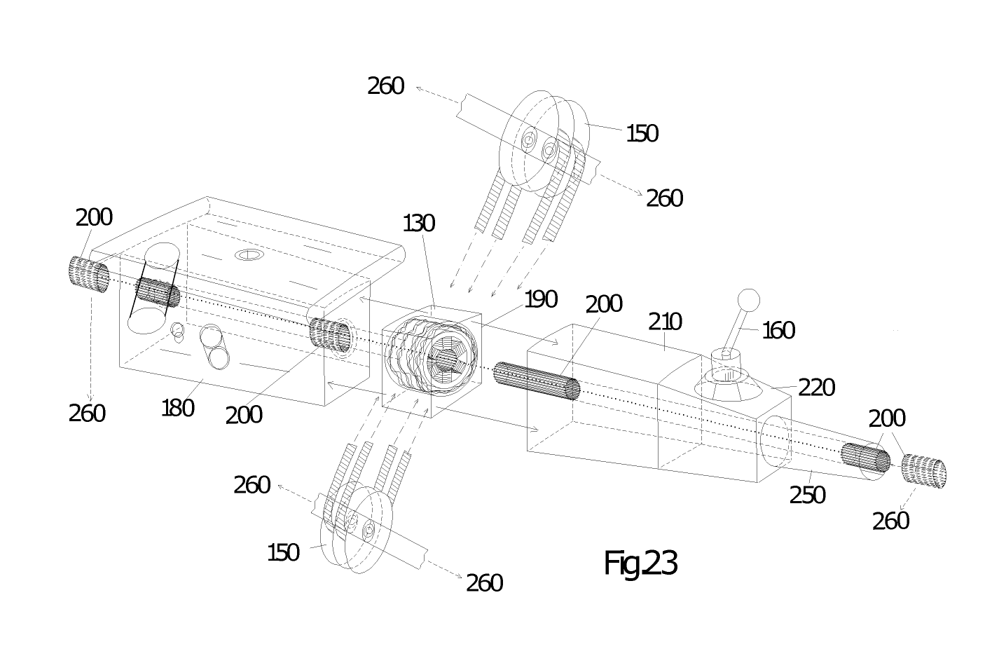

### FIG. 23

In an alternative embodiment of the AGS Motor System 170 the Motor 180 connects to the Transmission System 240. The Motor Shaft/Spline 200 component mechanically engages the Generator System 130 functioning with the Motor System 170, Transmission System 240 and the Gear/Flywheel/Spline/Pulley System 150.

### Advantages

A number of advantages of the AGS become evident to the reader of this specification that the AGS:
(1) Adapts the automobile motor to an automatic transmission system, manual transmission system or throttled motor operations in an automobile,
(2) Generates self-sustaining energy for the on-demand operation of the motor and accessory systems in an automobile,
(3) Continually recharges an automobile's battery system for any automobile motor or automobile electrical accessory need,
(4) Can be used in an automobile for constant, uninterrupted energy,
(5) Reduces the energy requirements of an automobile motor, enabling a smaller motor,
(6) Adapts a generator system to the automobile motor shaft/spline, motor, transmission, clutch/gearbox and/or motor housing of a motor system,
(7) Continually recharges a battery system while the engine is engaged,
(8) Adapts the automobile motor and transmission system to accommodate a large number of generator systems to reduce international dependence on fossil fuel,
(9) Allows mechanical linkages to be adapted to either end of an automobile motor system, or to both ends of an automobile motor system while operating a plurality of generators.

### CONCLUSIONS, RAMIFICATIONS, AND SCOPE

The AGS is useful and uniquely patentable in the public or private sectors given that the AGS solves a myriad of existing automobile motor problems, further innovates existing technology with self-sustaining, “greener” technology solutions relevant to an automobile motor, and introduces new innovations into the relevant art in the field.

What is claimed is:

1. An automobile Generator System (AGS) having one or more power or load devices to generate the energy necessary to maintain the uninterrupted, self-sustaining powered means for providing, or assisting in the production of movement of an automobile, comprising:
said devices comprised of the diverse motor operations of a plurality of motor components, and a plurality of supporting components of said devices;
said devices comprised of the diverse power and mechanical operations of a plurality of transmission components, and a plurality of supporting components of said devices;
said devices comprised of the diverse power and mechanical operations of a plurality of generator components, and a plurality of supporting components of said devices;
said devices, said motor components, said transmission components, said generator components and said supporting components position together comprising the structure of the automobile;
a motor system for the automobile comprised of a selected plurality of said devices, said motor components, said transmission components, said generator components and said supporting components providing and supplying energy for a plurality of automobile components and accessories,
the motor system comprised of the means to operate the automobile,
the motor system comprised of said motor joined to a transmission with the means to supply mechanical power to operate the automobile,
the automobile motor system is engaged with a transmission, clutch, gearbox and/or supporting components,
said transmission, clutch, gearbox and/or any supporting component comprising an automobile transmission system,
the motor system is comprised of the means to mechanically engage a generator system to provide energy to operate the automobile,
the motor system comprised of a plurality of rotatably fixed gear, spline, flywheel, pulley components and/or their supporting components that mechanically engage the motor, transmission and/or generator system to provide energy to operate the automobile,
the motor system comprised of an automobile battery system,
the motor system comprised of a plurality of system controller components that distribute and monitor energy supplied to and from the automobile battery system, motor system, system controller, generator system and/or the automobile's electrical accessories,
a motor system, generator system and/or battery system to provide energy for a plurality of batteries to provide additional energy to operate the automobile;
an automobile transmission system comprised of the transmission component and a plurality of the generator system component, clutch component, gearbox component, housing component, motor housing component, spline component, other generic generator and/or transmission components, or combinations thereof, or
an automobile transmission system comprised of the transmission component and a plurality of generator systems, clutches, gearboxes, housings, motor housings, splines, pulleys, other generic generator and/or transmission components, or combinations thereof;
the automobile transmission system transfers mechanical power from the motor system to a plurality of mechanical linkages, gears, flywheels, splines, pulleys, generators, alternators, alternator-generators, shafts, axles, wheels, other generic motor system components, or combinations thereof to operate the automobile,
one automobile transmission system comprising one component of the motor system;
the automobile generator system is provided for supplying electric energy to the motor system, transmission system, system controller, automobile battery system, electrical accessories and/or their supporting components in which means are also provided for controlling automobile motor system operation,
generator system components are protected from adverse environmental conditions by the housing component,
the generator system functions to mechanically engage the motor and provide additional electric energy for the automobile's use,
an automobile generator system comprised of a plurality of alternators, generators, alternator-generators, magnet devices, stators, splines, pulleys, other generic motor system components, or combinations thereof that mechanically join and/or attach to the motor system, or an automobile generator system comprised of a plurality of alternator components, generator components, alternator-generator components, magnet device components, stator components, spline components, pulley components, other generic motor system components, or combinations thereof that mechanically join and/or attach to the motor system,
the generator system generates and transfers electric energy to the automobile motor system, automobile transmission system, automobile battery system, automobile electrical accessory system, a plurality of the system controller component, other generic automobile motor system components, or combinations thereof,
the generator system has sufficient energy output to charge the battery system and to operate automobile electrical accessories and/or the automobile motor system at full capacity,
the generator system mechanically provides electric energy to the system controller while the motor system and/or battery system is engaged,
the generator system comprised of a plurality of the planetary gear, spline, pulley, flywheel and/or their supporting components that mechanically engage the automobile motor system,
the motor system comprised with a plurality of the planetary gear, spline, pulley, flywheel and/or their supporting components that align to and provide mechanical rotation for a plurality of appropriate or opposite automobile generator system components,
said motor system and said generator system mechanically synchronize to the rotational speed of the motor system;
the operational speed of said motor system is variably and selectively controlled through the system controller functioning with a gas pedal, variable resistor and/or switch system or other suitable device,
the system controller comprised of the means to monitor the fuel or energy powering the motor, and/or the motor system is comprised with a gearshift/throttle system with the means to provide input to the system controller monitoring motor system functions;
the operational speed of each generator component is controlled by its mechanical connection to the automobile motor system;
the motor system comprised of an optional pulley system,
the motor system comprised of a plurality of pulley system components to allow mechanical power, torque, and speed to be transmitted across axles to operate the automobile,
the pulley system comprised of a plurality of wheel blocks, axles, wires and/or belts mechanically engaging the motor system,
the pulley system mechanically engaging a plurality of generator system components,
the pulley system mechanically engaging a plurality of motor system components and/or the pulley system mechanically engaging a plurality of generator system components to operate the automobile;
the system controller comprised of circuitry, software and/or hardware components to maintain and monitor AGS functions including, but not limited to motor system operation, transmission system operation, generator system operation, battery system operations, electrical accessory operations, AGS operational status,
the system controller functions to process and evaluate the automobile's energy operations and requirements as needed,
the system controller functions to process and evaluate the automobile's mechanical operations and requirements as needed,
the AGS comprised of a plurality of the system controller component that monitors the motor system's operational status and maintains the energy needed throughout the automobile,
the system controller functions throughout the AGS to manage electrical, chemical and/or mechanical energy flow in the automobile's motor system,
the system controller selectively or automatically engages, disengages and/or bypasses a plurality of automobile functions,
the system controller is a component of the automobile motor system, transmission system, generator system and/or battery system, and manages energy and/or data output from the automobile motor, transmission, generator, electrical accessory and/or battery system to maintain automobile operations,
the system controller functions to monitor and distribute AGS energy,
the system controller maintains maximum battery storage functionality and discards any excess energy produced and not used for battery, motor system and/or other automobile operations while the automobile is engaged;
the battery system optimally maintains the energy needed for the motor system's mechanical or electrical operations while the automobile is engaged,
the battery system and generator system optimally maintain the energy needed for the motor system's self-sustaining mechanical or electrical operations while the automobile is engaged,
the automobile battery system comprised of a plurality of batteries,
the automobile battery system with the means to store and provide energy for motor system, transmission system, generator system, electrical accessory system and/or supporting component operations,
battery system operations are manually or automatically engaged and/or disengaged by the system controller maintaining and/or monitoring AGS functions;
batteries comprising the battery system chemically store the energy transferred from the generator system, motor system and/or their supporting components,
the automobile battery system comprised of a plurality of rechargeable batteries that store sufficient energy to mechanically engage the automobile motor's cold start functions;
automobile electrical accessories comprised of a plurality of LED lights, light fixtures, switches, radios, heaters, other generic automobile components, or combinations thereof directly or indirectly connected to the battery system, transmission system, generator system, system controller and/or supporting components to maintain automobile functionality;
AGS components comprised of a transmission and a plurality of motors, clutches, gearboxes, mechanical linkages, generators, alternators, alternator-generators, housings, motor housings, gears, flywheels, axles, rotating shafts, splines, pulleys, system controllers, wires, electrical accessories, wheels, gearshifts/throttles, steering wheels, other generic automobile components or combinations thereof with the means to operate the automobile;
said AGS components are attached to the automobile structure, or a newly designed automobile is comprised with said AGS components.

2. The device of claim 1, in combination with an automobile motor system comprised of a power or load device component mechanically engaging a plurality of wheels, mechanically engaging electric generator energy output, mechanically engaging automobile battery recharging energy output, mechanically engaging a plurality of automobile electrical accessory devices such as a radio, a heater, an air conditioner, window switches, etc. and/or mechanically engaging their supporting components;
the automobile motor system comprised of a transmission and a plurality of motors, clutches, gearboxes, mechanical linkages, generators, alternators, alternator-generators, housings and motor housings, gears, flywheels, shafts, splines, pulleys, inverters, rectifiers, batteries, system controllers, other generic automobile components, or combinations thereof,
the automobile motor system comprised of a plurality of the mechanical linkage, spline and/or motor shaft component that mechanically engage or connect to a plurality of wheels, gears, flywheels, belts, shafts, splines, pulleys, axles, other mechanical linkage components, other generic automobile components other than a second transmission, or combinations thereof,
the motor system engages a plurality of the mechanical linkage component providing the moveable means for said wheels, gears, flywheels, belts, shafts, splines, pulleys, axles, other mechanical linkage components, other generic automobile components other than a second transmission, or combinations thereof to operate an automobile, or the motor system engages the motor shaft and/or spline component that mechanically engage wheel rotation, gear rotation, flywheel rotation, shaft rotation, spline rotation, pulley rotation, the mechanical linkage function, other generic automobile component functions other than a second transmission, or combinations thereof to operate an automobile,
a plurality of the motor component, spline component, motor shaft component, pulley component, and/or their supporting components mechanically engage a plurality of mechanical linkages to operate an automobile,
a plurality of the motor component, spline component, pulley component, motor shaft component and/or their supporting components mechanically engage a plurality of said wheels, gears, flywheels, belts, shafts, splines, pulleys, axles, other mechanical linkage components, other generic automobile components other than a second transmission, or combinations thereof to operate an automobile,
the automobile motor system is engaged with a transmission, clutch, gearbox and/or their supporting components, and/or is engaged without a clutch and/or gearbox in a throttled or constant-speed motor system comprising a transmission system;
the automobile motor system comprised of a motor and generator system,
the automobile motor system comprised with a plurality of planetary gear, spline, pulley, flywheel and/or supporting components that mechanically engage the generator system to provide mechanical rotation for each generator system component mechanically synchronized to the rotational speed of the automobile motor system, and/or an automobile motor system comprised with a motor shaft, spline, pulley and/or their supporting components that align through and mechanically engage the generator system functioning with the automobile motor and/or transmission system;
the automobile motor system, the automobile generator system and/or automobile transmission system mechanically engage a plurality of the mechanical linkage component;
a plurality of the mechanical linkage component functions to mechanically engage automobile wheels, gears, pulleys, flywheels, belts, shafts, axles, other mechanical linkage components, other generic automobile components other than a second transmission, or combinations thereof to operate an automobile, or each mechanical linkage component attaches to an axle, a shaft, a pulley, a spline and/or their supporting components functioning to mechanically engage automobile movement;
an automobile generator system comprised of a plurality of gears, splines, pulleys, flywheels and/or their supporting components, and an automobile motor system comprised of a plurality of suitably aligned gears, splines, pulleys, flywheels and/or their supporting components whereby the generator system and motor system mechanically engage each other,
each generator system gear, spline, pulley, flywheel and/or their supporting component plurality align to and/or through and mechanically engage an opposite or suitable motor system gear, spline, pulley, flywheel and/or their supporting component plurality to provide automobile electric energy;
a plurality of the housing component covers an appropriate surface area of each generator system component exposed to adverse environmental conditions, and joins and/or attaches to an automobile component or automobile motor system component,
the housing component, either individually or as one all-inclusive component, optionally shelters each generator system component attached to or joined to the automobile motor system,
each housing component in the automobile is securely attached or bolted to the motor system, transmission system, generator system, motor housing, clutch, gearbox, other generic automobile component and/or the automobile structure.

3. The AGS comprised of the many variations, alternatives, and equivalents of the various elements of the invention constructed from at least one of metals, epoxies, ceramics, woods, or plastics that return approximately 100% of the energy provided by at least one automobile motor,
said automobile motor comprised of a plurality of said AGS components of claims 1 and 2 comprised of the means to return said energy, provide energy to the motor, motor system, transmission system, generator system, electrical accessories, automobile battery system and/or their supporting components and continually operate the automobile;
said energy provided may be reduced by the expected inefficiency of AGS components and/or the normal inefficiency of the automobile as it ages, wears out with use, breaks, environmentally deteriorates, produces heat from friction, etc. over time;
said many variations, alternatives, and equivalents of the various elements of the invention can be made within the scope of the invention and the many options that can be added to operate the automobile fall within the scope of the invention, and such embodiments can be included within the spirit of the claims above.
